(19) United States
(12) Patent Application Publication
(10) Pub. No.: US 2006/0261001 A1
(43) Pub. Date: Nov. 23, 2006

(54) Filter sector for use in rotary disc filters for separating pulp suspensions

(76) Inventor: Conny Hagg, Huddinge (SE)

Correspondence Address: YOUNG & THOMPSON, 745 SOUTH 23RD STREET, 2ND FLOOR, ARLINGTON, VA, 22202, US

(21) Appl. No.: 10/543,127

(22) PCT Filed: Jan. 12, 2004
(86) PCT No.: PCT/SE04/00014

§ 371 Date: Apr. 24, 2006

(30) Foreign Application Priority Data
Jan. 23, 2003 (SE) 0300169-0

(51) Int. Cl. B01D 39/00

(52) U.S. Cl. 210/486; 210/499

(57) ABSTRACT

A filter sector (1) for use in rotary disc filters for separating pulp suspensions has opposite filtration walls (2) of a substantially rigid net, wherein a filtrate chamber (4) is formed between the filtration walls for receiving filtrate that has flowed through the filtration walls. Each filtration wall is profiled to form a multiplicity of cavities (5) and humps (6), and each cavity and hump, respectively, includes a multiplicity of meshes of the net. The provision of cavities and humps increases the effective filtering area of the filter sector, which results in increased capacity of the filter sector.

The present invention relates to a filter sector for use in rotary disc filters for separating suspensions, such as pulp suspensions. The filter sector comprises a first filtration wall of a substantially rigid net, and a second filtration wall of a substantially rigid net opposite the first filtration wall, a filtrate chamber being formed between the first and second filtration walls for receiving filtrate that has flowed through the first and second filtration walls. The filtrations walls are profiled to increase the filtration capacity of the filter sector. Filter sectors of this kind are assembled to form circular filter discs for rotary disc filters.

In a known filter sector of this kind, according to Swedish patent application 9901154-6, the filtration walls of net are corrugated to form a plurality of ridges and valleys. As a result, the known filter sector has a greater filtration capacity than that of a traditional filter sector having planar walls of filter cloth.

The object of the present invention is to provide a new filter sector that also has a greater filtration capacity than that of a traditional filter sector.

This object is obtained by the filter sector described initially characterised in that each filtration wall is profiled to form a multiplicity of cavities and humps, and that each cavity and hump, respectively, includes a multiplicity of meshes of the net. As a result, the effective filtration area of the filter sector is increased as compared with a filter sector of the same size with planar walls of net, whereby the filtration capacity of the filter sector of the invention is improved.

In a preferred embodiment of the invention, the cavities and humps, respectively, are oriented in rows with the rows of cavities alternating with the rows of humps.

Advantageously, weaving forms the cavities and humps of the net, i.e. a special weaving technique is employed while weaving the net, which makes the new filter sector inexpensive to manufacture. Alternatively, pressing may form the cavities and humps of the net.

Each cavity and hump, respectively, may be defined by four straight sides, wherein each straight side of a cavity is common to one of the four straight sides of an adjacent hump.

The first and second walls of the net may take the shape of a bag.

In another embodiment of the invention, the filter sector comprises first and second support walls made of a planar metal net that is coarser than the net of the filtration walls, wherein the first and second support walls support the first and second filtration walls, respectively. The support walls may be joined to each other at the radial sides of the filter sector, whereby the filtration walls and support walls form a bag-shaped filter unit.

The present invention is described in more detail in the following with reference to the accompanying drawings, in which

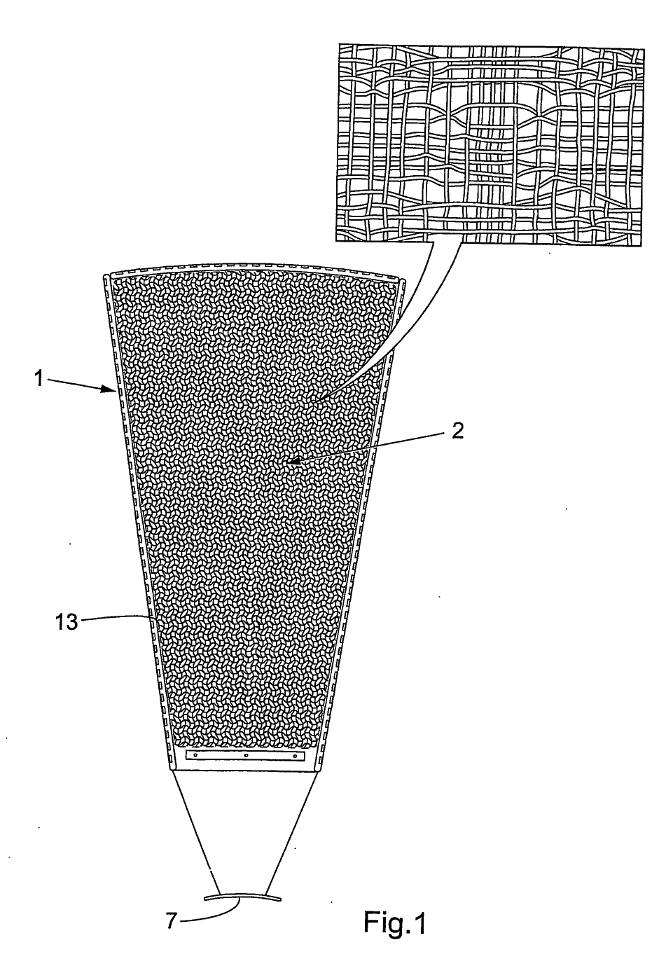

FIG. 1 is a front view of an embodiment of the filter sector according to the present invention,

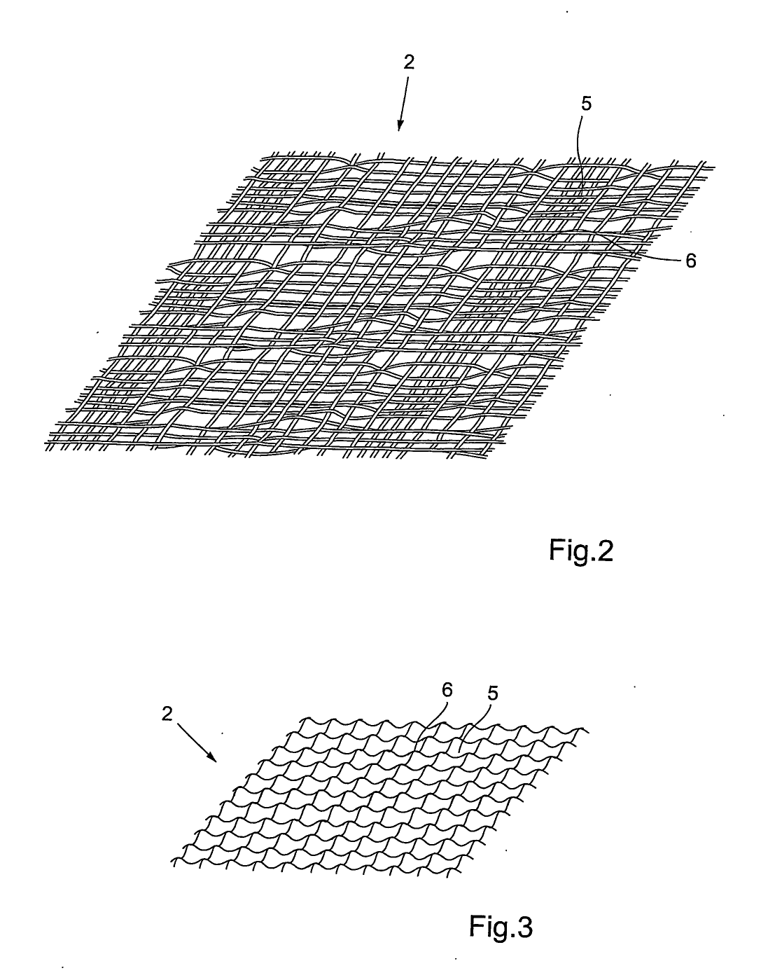

FIG. 2 is an enlarged detail of the filtration net wall of the filter sector shown in FIG. 1, illustrating the woven pattern of the net,

FIG. 3 schematically illustrates humps and cavities formed in the filtration net wall,

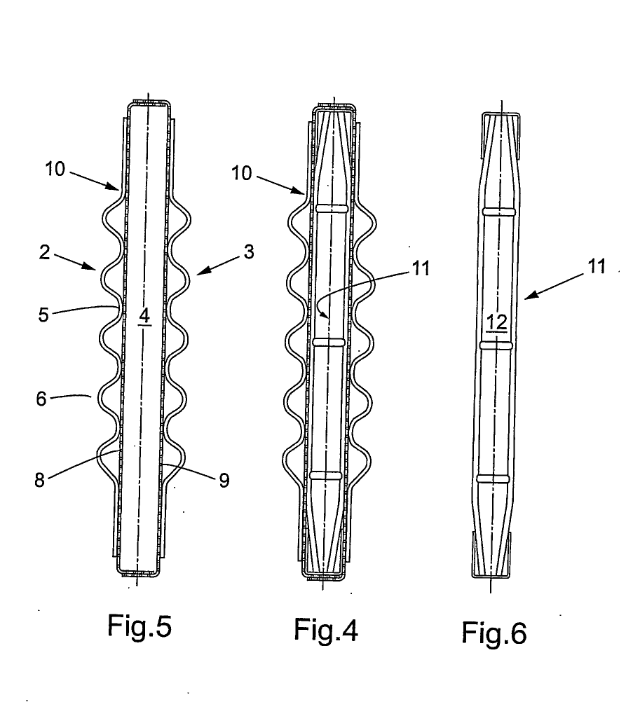

FIG. 4 is a sectional view of the filter sector of FIG. 1,

FIG. 5 is a filter unit forming part of the embodiment shown in FIG. 4, and

FIG. 6 is a sector frame forming part of the embodiment shown in FIG. 4.

FIG. 1 shows a filter sector 1 according to an embodiment of the present invention comprising two opposite filtration walls 2 and 3 of a substantially rigid metal net defining a filtrate chamber 4 for receiving filtrate that has flowed through the filtration walls 2,3. Each filtration net wall 2 and 3, respectively, is woven in accordance with a special pattern that forms a multiplicity of four-sided cavities 5 and humps 6, each of which includes a multiplicity of meshes of the net. FIG. 2 illustrates the individual threads in this pattern and FIG. 3 schematically illustrates the resulted cavities 5 and humps 6 of the net walls 2,3.

A filtrate outlet 7 for filtrate that has flowed through the filtration walls 2,3 to the filtrate chamber 4 is provided at the radial inner end of the filter sector 1. A plurality of such filter sectors 1 are intended to be assembled to form a circular filter disc that is used in a rotary disc filter for separating suspensions, such as fibre pulp suspensions.

With reference to FIGS. 4-6, the filtration walls 2 and 3 are joined to two stiff support walls 8 and 9, respectively, made of a planar metal net that is coarser than the net of the filtration walls 2,3. The support walls 8,9 are joined to each other at the radial sides of the filter sector 1, whereby the filtration walls 2,3 and support walls 8,9 form a bag-shaped filter unit 10. (As an alternative, however, the support walls 8,9 may not be joined together, so that the filtration wall 2 and support wall 8 form a first separate unit and the filtration wall 3 and support wall 9 form a second separate unit.) The bag-shaped filter unit 10 fits on a sector-shaped rigid grid frame 11 that forms a central filtrate channel 12. The assemblage of the bag-shaped unit 10 and the grid frame 11 (illustrated in FIG. 4) is releasably secured to a frame 13 of the filter sector 1.

In case the specific use of the filter sector 1 permits a design of the filtration walls 2,3 in which the metal net can be made stiff enough, the support walls 8,9 of coarser net may be omitted. In such a case the filtration walls 2,3 may either be separate from each other or be joined to each other to form a bag-shaped unit.

In operation, several filter sectors 1 are joined to one another to form a filter disc, which is rotated partially immersed in a pool of a suspension to be separated. A pressure difference is created across the filtration walls 2,3 while they are immersed in the suspension during the rotation of the disc, so that a filtrate of the suspension is pressed through the filtration walls 2,3 into the filtrate chamber 4, while coarse particles, such as fibres, of the suspension deposit on the external sides of the filtration walls 2,3. The filtrate flows further through the support walls 8,9 of coarser metal net into the filtrate channel 12. In the filtrate channel 12 the filtrate changes flow direction from a substantially axial direction to a substantially radially inward direction towards the filtrate outlet 7. The separated coarse particles are normally removed from the filtration walls 2,3, as they are above the pool of suspension, by the action of liquid jets sprayed onto the filtration walls 2,3.

1. A filter sector (1) for use in rotary disc filters for separating suspensions, the filter sector comprising a first filtration wall (2) of a substantially rigid net, and a second filtration wall (3) of a substantially rigid net opposite the first filtration wall, a filtrate chamber (4) being formed between the first and second filtration walls for receiving filtrate that has flowed through the first and second filtration walls, wherein the filtrations walls are profiled to increase the filtration capacity of the filter sector, characterised in that each filtration wall (2,3) is profiled to form a multiplicity of cavities (5) and humps (6), and that each cavity and hump, respectively, includes a multiplicity of meshes of the net.

2. A filter sector according to claim 1, wherein the cavities (5) and humps (6), respectively, are oriented in rows with the rows of cavities alternating with the rows of humps.

3. A filter sector according to claim 1, wherein the cavities (5) and humps (6) are formed by weaving the net.

4. A filter sector according to claim 1, wherein the cavities (5) and humps (6) are formed by pressing.

5. A filter sector according to claim 1, wherein each cavity (5) and hump (6), respectively, is defined by four straight sides.

6. A filter sector according to claim 5, wherein each straight side of a cavity (5) is common to one of the four straight sides of an adjacent hump (6).

7. A filter sector according to claim 1, wherein the first and second filtration walls (2, 3) of the net take the shape of a bag.

8. A filter sector according to claim 1, further comprising first and second support walls (8,9) made of a planar metal net that is coarser than the net of the filtration walls (2,3), wherein the first and second support walls support the first and second filtration walls, respectively.

9. A filter sector according to claim 8, wherein the support walls (8,9) are joined to each other at the radial sides of the filter sector, whereby the filtration walls (2,3) and support walls (8,9) form a bag-shaped filter unit (10).

10. A filter sector according to claim 1, wherein the net of the filtration walls (2, 3) comprises a metal net.

11. A filter sector according to claim 2, wherein the cavities (5) and humps (6) are formed by weaving the net.

12. A filter sector according to claim 2, wherein the cavities (5) and humps (6) are formed by pressing.
